(19) United States
(12) Patent Application Publication
(10) Pub. No.: US 2025/0387894 A1
(43) Pub. Date: Dec. 25, 2025

(54) SYSTEMS AND METHODS FOR REMOTE POWER TOOL DEVICE CONTROL

(71) Applicant: TECHTRONIC CORDLESS GP, Anderson, SC (US)

(72) Inventors: Mark Huggins, Anderson, SC (US); Tyler J. Rowe, Anderson, SC (US); Frederick W. Bryan, Greenville, SC (US); Mark K. Stokes, Clemson, SC (US)

(21) Appl. No.: 19/306,494

(22) Filed: Aug. 21, 2025

Related U.S. Application Data
(63) Continuation of application No. 18/392,617, filed on Dec. 21, 2023, now Pat. No. 12,397,406.
Application No. 18/392,617 is a continuation of application No. 17/812,107, filed on Jul. 12, 2022, now Pat. No. 11,890,738.
Application No. 17/812,107 is a continuation of application No. 17/236,442, filed on Apr. 21, 2021, now Pat. No. 11,386,774.
Application No. 17/236,442 is a continuation of application No. 16/524,970, filed on Jul. 29, 2019, now Pat. No. 11,011,053.
(60) Provisional application No. 62/712,473, filed on Jul. 31, 2018.

(51) Int. Cl. B25F 5/00; G08C 17/02; H01M 10/42; H02J 7/00

(52) U.S. Cl. CPC B25F 5/00; G08C 17/02; H01M 10/425; H02J 7/00032; H01M 2010/4271; H01M 2010/4278; H01M 2220/30; H02J 7/0063

(57) ABSTRACT

Systems and methods for remote power tool control are provided. In one example, a battery pack is coupled to a power tool device. The battery pack includes a pack transceiver and a pack electronic processor. The pack electronic processor is coupled to the pack transceiver and is configured to determine that the power tool device is remotely controllable. The pack electronic processor is further configured to receive, wirelessly via a pack transceiver of the battery pack, a remote control command from a mobile device, and to provide the remote control command to the power tool device. The system further includes a tool electronic processor of the power tool device in communication with the pack electronic processor. The tool electronic processor is configured to control the power tool device to perform an action specified by the remote control command in response to receiving the remote control command.

### CROSS-REFERENCE TO RELATED APPLICATION

This application is a continuation of U.S. patent application Ser. No. 18/392,617, filed Dec. 21, 2023, which is a continuation of U.S. patent application Ser. No. 17/812,107, filed Jul. 12, 2022, which is a continuation of U.S. patent application Ser. No. 17/236,442, filed Apr. 21, 2021, now U.S. Pat. No. 11,386,774, which is a continuation of U.S. patent application Ser. No. 16/524,970, filed Jul. 29, 2019, now U.S. Pat. No. 11,011,053, which claims the benefit of U.S. Provisional Patent Application No. 62/712,473, filed on Jul. 31, 2018, the entire content of each of which is hereby incorporated by reference.

### FIELD OF THE INVENTION

This application relates to controlling power tools with a mobile device through a battery pack of the power tool.

### BRIEF DESCRIPTION OF THE SEVERAL VIEWS OF THE DRAWINGS

FIG. 1 is a communication system including a mobile device, a battery pack, and power tools.

FIG. 2 is a block diagram of the battery pack and the power tool of FIG. 1 in accordance with some embodiments.

FIG. 3 is a block diagram of the mobile device of FIG. 1 in accordance with some embodiments.

FIG. 4 is a flowchart of a method for remotely controlling the power tool device of FIG. 1 in accordance with some embodiments.

FIG. 5 is a system for communication between a miter saw and a shop vacuum through battery packs and the mobile device in accordance with some embodiments.

FIG. 6 is a flowchart of a method for automating dust collection during operation of the miter saw of FIG. 5 in accordance with some embodiments.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

One embodiment discloses a system for remote controlling a power tool device. The system includes a battery pack coupled to a power tool device. The battery pack includes a pack memory, a pack transceiver, and a pack electronic processor. The pack electronic processor is coupled to the pack memory and the pack transceiver and is configured to determine that the power tool device is remotely controllable. The pack electronic processor is further configured to receive, wirelessly via a pack transceiver of the battery pack, a remote control command from a mobile device, and to provide the remote control command to the power tool device. The system further includes a tool electronic processor of the power tool device in communication with the pack electronic processor. The tool electronic processor is configured to control the power tool device to perform an action specified by the remote control command in response to receiving the remote control command. In some examples, the tool electronic processor is further configured to place the power tool device in a remote control mode in response to user input.

Another embodiment provides a method for remote controlling a power tool device. The power tool device is powered by a battery pack. The method includes determining, by a pack electronic processor of the battery pack, that the power tool device is remotely controllable and receiving, wirelessly via a pack transceiver of the battery pack, a remote control command from a mobile device. The method also includes providing the remote control command, by the pack electronic processor to the tool electronic processor of the power tool device, and controlling, using the tool electronic processor, the power tool device to perform an action specified by the remote control command in response to the tool electronic processor receiving the remote control command. In some examples, the method further includes placing the power tool device in a remote control mode in response to user input.

Another embodiment provides a battery pack connectable to a power tool device and configured to facilitate remote control of the power tool device by a mobile device. The battery pack includes a plurality of cells providing operating power to the power tool device, wherein the power tool device is coupled to the battery pack and a pack transceiver. The battery pack also includes a pack electronic processor electrically coupled to the transceiver. The pack electronic processor is further configured to determine that the connected power tool device is remotely controllable and receive, wirelessly via the pack transceiver, a remote control command from the mobile device. The pack electronic processor is also configured to provide, via a communication link between the pack electronic processor and a tool electronic processor of the power tool device, the remote control command. The remote control command specifies an action to be performed by the power tool device. In some examples, the power tool device performs the function specified by the remote control command in response to receiving the remote control command.

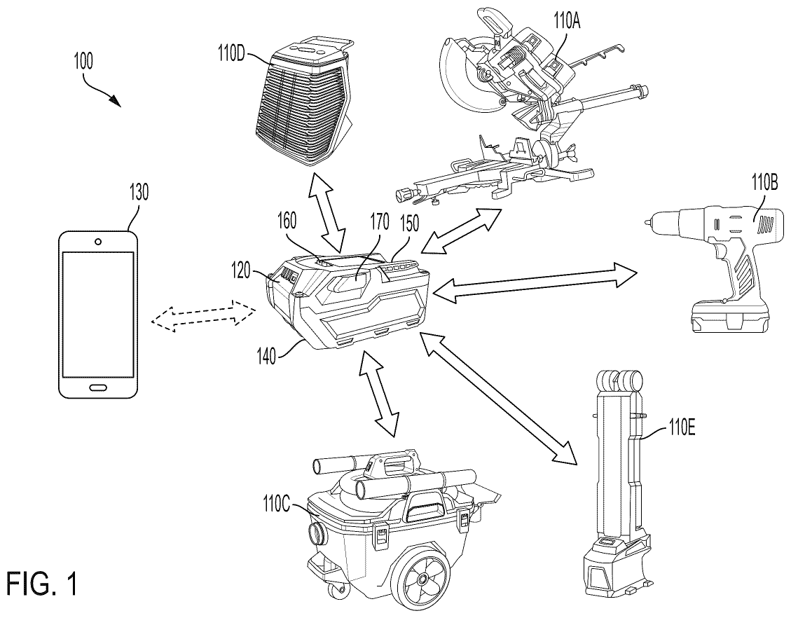

FIG. 1 illustrates a communication system 100 including various power tool devices 110 powered by a battery pack 120. The system 100 also includes a mobile device 130 that can control the power tool devices 110 through the battery pack 120. The power tool devices 110 may include motorized power tool devices (for example, a miter saw 110A, a drill-driver 110B, a shop vacuum 110C, and the like) or non-motorized electrical devices (for example, a work radio 110D, a work light 110E, and the like). Each of the power tool devices 110A-E may be individually referred to as the power tool device 110, or collectively as the power tool devices 110. At least in some embodiments, the power tool devices 110 may be described as electrically powered devices that are configured to be coupled to and powered by a power tool battery pack (e.g., the battery pack 120) that is configured to be coupled to and power a motorized power tool (e.g., a drill, a saw, and the like).

The battery pack 120 is a power tool battery pack having a nominal voltage of, for example, 12 Volts, 18 Volts, and the like. The battery pack 120 includes a housing 140, a tool interface 150, and a latch 160 controlled by actuator 170 to selectively latch the tool interface 150 to a battery interface of the power tool 110. The mobile device 130 is a mobile communication device, for example, a smart telephone, a tablet computer, a laptop computer, a personal digital assistant, a smart wearable device (e.g., smart watch), and the like.

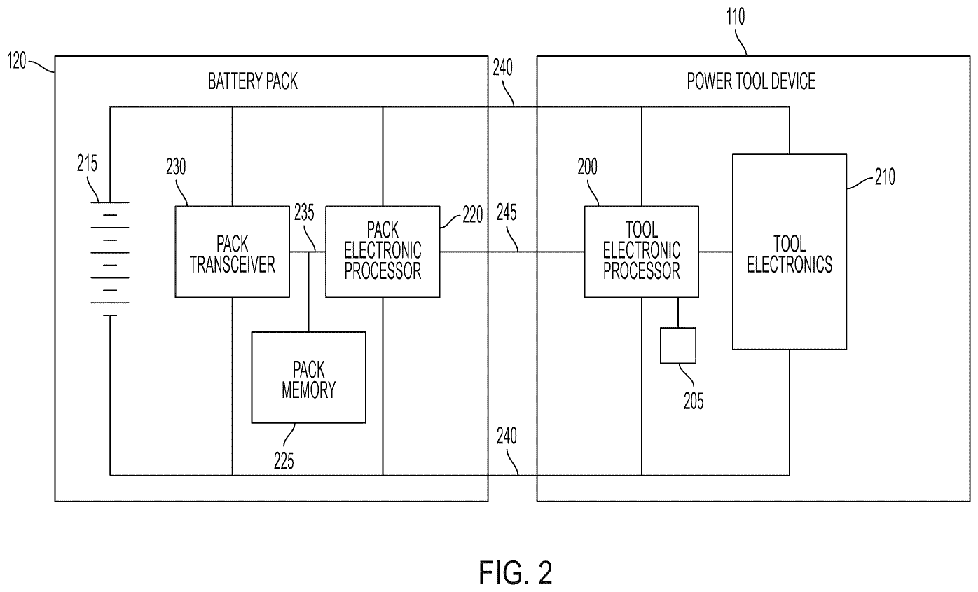

With reference to FIG. 2, the power tool device 110 includes a tool electronic processor 200, a tool memory 205, and tool electronics 210. The tool electronic processor 200 may be implemented as, for example, a microprocessor, a microcontroller, a field programmable gate array, an application specific integrated circuit, or the like. The tool memory 205 may be a part of the tool electronic processor 200 or may be a separate component. The tool memory 205 may include, for example, a program storage area and a data storage area. The tool memory 205 stores executable instructions that when executed by the tool electronic processor 200, cause the power tool device 110 to perform the functions described herein. For example, the tool electronic processor 200 controls the functions of the power tool device 110 and enables communication between the power tool device 110 and the battery pack 120. The tool electronics 210 may include a switch bridge and a motor (not shown) when the power tool device 110 is a motorized power tool and may include other electronics (e.g., LEDs, radio transceiver, speaker, and the like) when the power tool device 110 is a non-motorized electronic device. The tool electronics 210 are controlled by the tool electronic processor 200. For example, the tool electronic processor 200 is configured to one or more of enable the tool electronics 210, disable the tool electronics 210, and modify operating characteristics (e.g., motor power, LED brightness, radio tuning, speaker volume, and the like).

The battery pack 120 includes battery cells 215, a pack electronic processor 220, a pack memory 225, and a pack transceiver 230 within the housing 140. The pack electronic processor 220, the pack memory 225, and the pack transceiver 230 communicate over one or more control and or data buses (for example, a communication bus 235). The battery cells 215 may be arranged in a series, parallel, or series-parallel combination. For example, the battery cells 215 include one or more series strings of five cells connected in parallel. In some embodiments, the battery cells 215 have a lithium-ion based chemistry and each provide approximately 3.6 nominal voltage. In other embodiments, the battery cells 215 have different chemistry, voltage output, or both. The battery cells 215 provide operating power to the other components of the battery pack 120. Additionally, operating power from the battery cells 215 is provided to the power tool device 110 over power terminals 240.

The pack electronic processor 220 may be implemented as, for example, a microprocessor, a microcontroller, a field programmable gate array, an application specific integrated circuit, or the like. The pack memory 225 may be a part of the pack electronic processor 220 or may be a separate component. The pack memory 225 may include, for example, a program storage area and a data storage area. The pack memory 225 stores executable instructions that when executed by the pack electronic processor 220, cause the battery pack 120 to perform the functions described herein. The pack electronic processor 220 communicates with the tool electronic processor 200 over a communication terminal 245 to exchange data and control signals. The communication terminals 245 may implement a serial communication system for example, an RS-485 link or the like to facilitate communications between the pack electronic processor 220 and the tool electronic processor 200. In some embodiments, rather than over the communication terminal 245, the pack electronic processor 220 and the tool electronic processor 200 may communicate over near-field wireless communication link, for example, a Bluetooth® connection or the like. In such embodiments, the power tool device 110 and battery pack 120 include respective wireless transceivers to facilitate the wireless communications.

The pack transceiver 230 facilitates communication between the battery pack 120 and an external device, for example, the mobile device 130 over a wireless communication network. In some embodiments, the pack transceiver 230 includes a combined transmitter-receiver component. In other embodiments, the pack transceiver 230 includes separate transmitter and receiver components.

The power tool device 110 and the battery pack 120 may include more or fewer components and may perform functions other than those described herein.

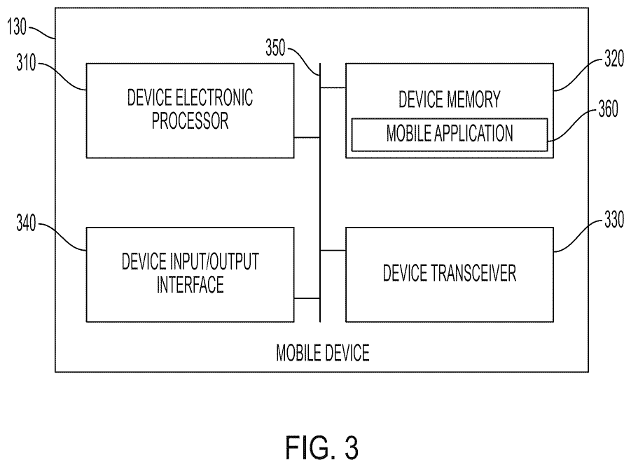

With reference to FIG. 3, the mobile device 130 includes a device electronic processor 310, a device memory 320, a device transceiver 330, and device input/output interface 340. The device electronic processor 310, the device memory 320, the device transceiver 330, and the device input/output interface 340 communicate over one or more control and/or data buses (for example, a communication bus 350). The mobile device 130 may include more or fewer components and may perform functions other than those described herein.

The device electronic processor 310 may be implemented as, for example, a microprocessor, a microcontroller, a field programmable gate array, an application specific integrated circuit, or the like. The device memory 320 may store executable instructions that are executed by the device electronic processor 310 to carry out the functionality of the mobile device 130 described herein.

The device transceiver 330 facilitates communication between the mobile device 130 and an external device, for example, the battery pack 120 over a wireless communication network. In some embodiments, the device transceiver 330 includes a combined transmitter-receiver component. In other embodiments, the device transceiver 330 includes separate transmitter and receiver components. The device transceiver 330 is controlled by the device electronic processor 310, for example, to transmit and receive data between the mobile device 130 and the battery pack 120.

The device input/output interface 340 may include one or more input mechanisms (e.g., a keypad, a mouse, and the like), one or more output mechanisms (e.g., a display, a speaker, and the like), or a combination of the two (e.g., a touch screen, or the like).

The mobile device 130 also includes a mobile application 360, which is an application designed for a mobile operating system for use on the mobile device 130. The device memory 320 may store the mobile application 360 and the device electronic processor 310 executes the mobile application 360 to enable the mobile device 130 to carry out the functionality of the mobile application 360 described herein. The mobile application 360 may communicate with the battery pack 120 over a connection between the mobile device 130 and the battery pack 120. The mobile application 360 may include a graphical user interface in that, execution of the mobile application 360 by the device electronic processor 310 may generate a graphical user interface on a display (e.g., input/output interface 340) of the mobile device 130. The mobile device 130 may convey information to a user through display of the graphical user interface and may receive user input via the graphical user interface (i.e., the input/output interface 340).

In some embodiments, the mobile device 130 (via the device transceiver 330) and the battery pack 120 (via the pack transceiver 230) communicate over a direct wireless connection, for example, a Bluetooth® connection, a ZigBee® connection, or the like. In other embodiments, the mobile device 130 (via the device transceiver 330) and the battery pack 120 (via the pack transceiver 230) communicate over an indirect wireless connection, for example, over a cellular network, over the Internet, or the like.

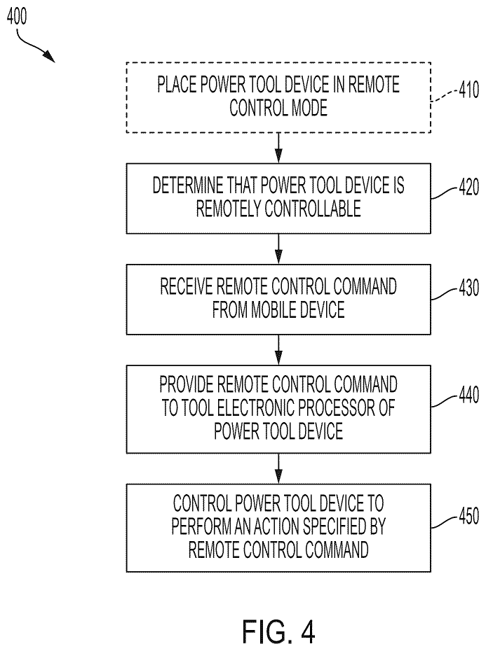

FIG. 4 is a flowchart illustrating an exemplary method 400 for remotely controlling the power tool device 110. As illustrated in FIG. 4, the method 400 includes placing the power tool device 110 in a remote control mode (at step 410). The power tool device 110 may include a mode switch (not shown) that can be actuated by a user to select a mode of the power tool device 110. For example, the mode switch may be between a first position for selecting the remote control mode and a second position for selecting a normal mode (i.e., deselecting the remote control mode) by the user. The tool electronic processor 200 receives position information of the mode switch and places the power tool device 110 in the selected mode. Particularly, the tool electronic processor 200 determines that the mode switch is in the first position and places the power tool device 110 in the remote control mode. When the power tool device 110 is in the remote control mode, the power tool device 110 can be remotely controlled by the mobile device 130 as described below. When the power tool device 110 is in the normal mode, the power tool device 110 ignores (e.g., discards) commands received from the mobile device 130 without executing the received commands. However, the step 410 of placing the power tool device 110 in a remote control mode is optional. For example, in some embodiments, the power tool device 110 may always be in a remote control mode such that the power tool device 110 can be remotely controlled by the mobile device 130.

The method 400 also includes determining, by the pack electronic processor 220, that the power tool device 110 is remotely controllable (at step 420). The remote control feature may not be provided on every power tool device 110 configured to be coupled to and powered by the battery pack 120. For example, the remote control feature may be provided on the work radio 110D, the work light 110E, and the shop vacuum 110C, but may not be provided on the miter saw 110A or the drill-driver 110B. In some embodiments, the pack electronic processor 220 determines whether the power tool device 110 is remotely controllable using identification signals received from the power tool device 110. For example, the tool electronic processor 200 communicates identification signals over the communication terminal 245 to the pack electronic processor 220.

The identification signals may include for example, a type of the power tool (e.g., by model number), which is then used by the pack electronic processor 220 to access and retrieve from a lookup table an indication of whether the power tool device 110 is remotely controllable. The lookup table may be on the stored on the pack memory 225, the device memory 320, or a combination thereof. In some embodiments, the identification signals include an explicit indication of whether the power tool device 110 is remotely controllable or not remotely controllable.

In some embodiments, the battery pack 120 includes a sensor in communication with the pack electronic processor 220 that is configured to detect whether the power tool device 110 is remotely controllable. For example, the sensor of the battery pack 120 may be a Hall effect sensor configured to detect a magnetic field, and the power tool device 110 that is remotely controllable may include a magnet near its battery pack interface. Upon coupling the power tool device 110 and the battery pack 120, the sensor provides an output to the pack electronic processor 220 indicative of the presence (or absence) of the magnet or indicative of the pole orientation of the magnet, and the output is indicative of whether the power tool device 110 is remotely controllable. Accordingly, power tool devices 110 having no such magnet, or having a magnet with a pole orientation representing that the device is not remotely controllable, are determined by the pack electronic processor 220 to be not remotely controllable. Power tool devices 110 having a magnet, or having a magnet with a pole orientation representing that the device is remotely controllable, are determined by the pack electronic processor 220 to be remotely controllable.

The method 400 further includes receiving, by the pack electronic processor 220, a remote control command from the mobile device 130 (at step 430). The remote control command can be a command to, for example, turn the power tool device ON/OFF, activate a motor of the power tool device, switch an LED ON/OFF, adjust a radio station tuning, adjust an LED brightness, adjust a speaker volume, adjust a motor speed, and the like. The command can be selected on a graphical user interface of the mobile application 360. The battery pack 120 may communicate the type or identification information of the power tool device 110 connected to the battery pack 120 to the mobile device 130. The mobile device 130 may display a list of commands a user can select on the graphical user interface of the mobile application 360. When the mobile device 130 receives a selection of the remote control command from the list of commands (e.g., based on user input received by the device input/output interface 340), the mobile device 130 transmits the remote control command to the battery pack 120 via the device transceiver 330. Particularly, the pack electronic processor 220 receives the remote control command wirelessly via the pack transceiver 230.

The method also includes providing, by the pack electronic processor 220, the remote control command to the tool electronic processor 200 of the power tool device 110 (at step 440). The pack electronic processor 220 relays the command received from the mobile device 130 to the tool electronic processor 200. As described above, the pack electronic processor 220 and the tool electronic processor 200 communicate over the communication terminal 245 or over a near-field communication link. The pack electronic processor 220 provides the remote control command to the tool electronic processor 200 via the communication terminal 245 or the near-field communication link. In some embodiments, the pack electronic processor 220 may provide remote control command in response to determining that the power tool device 110 is remotely controllable, that the power tool device 110 is in a remote control mode, or both.

The method 400 further includes controlling, by the tool electronic processor 200, the power tool device 110 to perform an action specified by the remote control command (at step 450). The tool electronic processor 200, in response to receiving the remote control command, controls the tool electronics 210 to perform the action specified by the remote control command. For example, the tool electronic processor 200 turns the power tool device ON/OFF, activates a motor of the power tool device, switches an LED ON/OFF, adjusts a radio station tuning, adjusts an LED brightness, adjusts a speaker volume, adjusts a motor speed, and the like. In some embodiments, the power tool device 110 operates in a lower power draw mode until a remote control command is received from the battery pack 120. In the low power draw mode, the power draw is sufficient to maintain communication with the battery pack 120 and monitor for remote control commands, but not sufficient to perform the actions specified by the remote control command. Upon receiving the remote control command, the tool electronic processor 200 switches the power tool device 110 to the high power draw mode to perform the action specified by the remote control command.

While the steps of the method 400 are illustrated in a particular serial order, in some embodiments, one or more of the steps are executed in parallel or in a different order than illustrated. For example, one or both of steps 410 and 420 may occur in parallel with or after step 430.

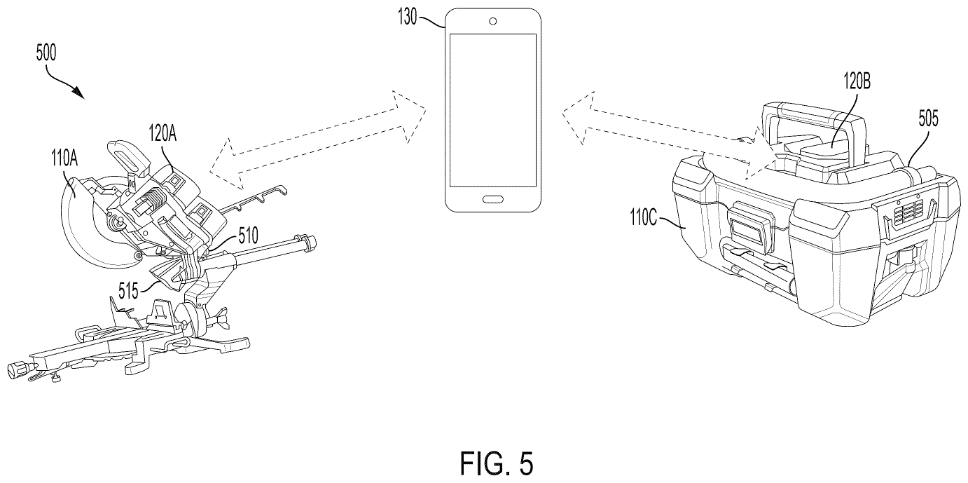

FIG. 5 illustrates one example system 500 for implementing a remote controlling of power tool devices 110. The system 500 includes the miter saw 110A (for example, a first power tool device) connected to a first battery pack 120A, the shop vacuum 110C (for example, a second power tool device) connected to a second battery pack 120B, and the mobile device 130. The first battery pack 120A and the second battery pack 120B are examples of the battery pack 120 described above. Accordingly, the description provided above with respect to the battery pack 120 similarly applies to the first battery pack 120A and the second battery pack 120B. The mobile device 130 wirelessly communicates with the first battery pack 120A and the second battery pack 120B as described above.

When the miter saw 110A is operated on a workpiece, the resulting cut may create dust that is deposited on the work bench. Users may use the shop vacuum 110C to clear the dust deposited by the miter saw 110A. However, the user may have to pause the current cut to vacuum excess dust, or operate the vacuum between successive cuts to clear dust. This dust removal may result in a user taking additional time to complete a project. In some embodiments, a hose 505 of the shop vacuum 110C is directly coupled to a dust port 510 of the miter saw 110A. The dust port 510 includes a dust intake end 515 near the saw blade to extract dust during a cut and a dust exhaust end, opposite the dust intake end 515, to expel extracted dust into the hose 505 coupled to the dust port. Still, users may need to manually turn on and off the shop vacuum 110 with each cut, or leave the shop vacuum 110 enabled between cuts despite a lack of dust needing extraction between cuts.

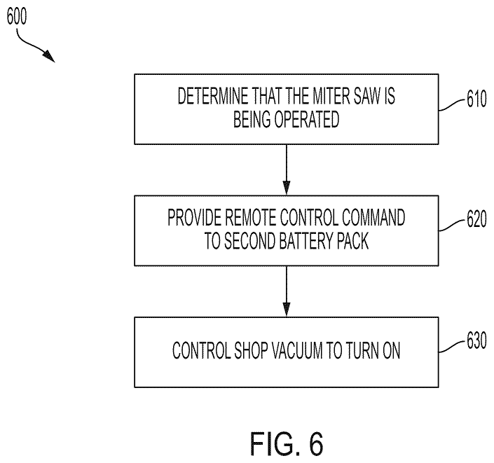

The dust collection process can be automated to be more efficient and to speed up the project by remotely controlling the shop vacuum 110C while the miter saw 110A is being operated. FIG. 6 is a flowchart illustrating an exemplary method 600 for automating dust collection during operation of a miter saw 110A. As illustrated in FIG. 6, the method 600 includes determining, by the device electronic processor 310, that the miter saw 110A (i.e., the first power tool device 110) is being operated (at step 610). For example, a pack electronic processor of the first battery pack 120A detects a power draw when the user operates the miter saw 110A, for example, using a current sensor electrically connected to the power terminals of the first battery pack 120A. The pack electronic processor of the first battery pack 120A sends a signal, via the pack transceiver, indicating that the miter saw 110A is being operated to the mobile device 130 in response to detecting the power draw. The device electronic processor 310 of the mobile device 130 determines that the miter saw 110A is being operated upon receiving this signal from the first battery pack 120A.

The method 600 also includes providing, by the device electronic processor 310, a remote control command to the second battery pack 120B in response to the determination that the miter saw 110A is being operated (at step 620). For example, in response to determining that the miter saw 110A is being operated, the device electronic processor 310 transmits the remote control command via the device transceiver 330, and the remote command is received by the second battery pack 120B. The remote control command is a request to turn the shop vacuum 110C (i.e., the second power tool 110) ON (i.e., to activate a motor of the shop vacuum 110C).

The method further includes controlling the shop vacuum to turn ON in response to the remote control command received by the second battery pack 120B (at step 630). For example, the pack electronic processor 220 of the second battery pack 120B relays the remote control command to the tool electronic processor 200 of the shop vacuum 110C. In response to the remote control command, the tool electronic processor 200 of the shop vacuum 110C switches the shop vacuum 110 from the low power draw mode to the high power draw mode and activates the motor of the shop vacuum 110C. Accordingly, the shop vacuum 110C may be operated essentially simultaneously with the miter saw 110A without any user intervention. In other words, when the miter saw 110A is activated by the user, the shop vacuum 110C is activated. This allows the dust collection process to be automated, which saves time for the user and provided a more efficient dust extraction.

In some embodiments, a similar technique is used to deactivate the shop vacuum 110C in response to deactivation of the miter saw 110 by the user. For example, after step 630, the device electronic processor 310 determines that the miter saw 110A (i.e., the first power tool device 110) has ceased being operated. For example, the pack electronic processor 220 of the first battery pack 120A detects a lack of power draw by the miter saw 110A in response to the user releasing a trigger of the saw. In turn, the pack electronic processor 220 of the first battery pack 120A sends a signal, via the pack transceiver, indicating that the miter saw 110A has ceased being operated to the mobile device. In response to receiving the signal, the device electronic processor 310 of the mobile device 130 determines that the miter saw 110A has ceased being operated.

Further, the device electronic processor 310 provides a second remote control command to the second battery pack 120B in response to the determination that the miter saw 110A has ceased being operated. For example, in response to determining that the miter saw 110A has ceased being operated, the device electronic processor 310 transmits the second remote control command via the device transceiver 330, and the second remote command is received by the second battery pack 120B. The second remote control command is a request to turn the shop vacuum 110C (i.e., the second power tool 110) OFF (i.e., to deactivate a motor of the shop vacuum 110C).

Further, the shop vacuum is controlled to turn OFF in response to the second remote control command received by the second battery pack 120B. For example, the pack electronic processor 220 of the second battery pack 120B relays the second remote control command to the tool electronic processor 200 of the shop vacuum 110C. In response to the remote control command, the tool electronic processor 200 of the shop vacuum 110C switches the shop vacuum 110 from the high power draw mode to the low power draw mode and deactivates the motor of the shop vacuum 110C. Accordingly, the shop vacuum 110C may be enabled and disabled essentially simultaneously with the miter saw 110A without any user intervention. In other words, when the miter saw 110A is activated by the user, the shop vacuum 110C is activated, and when the miter saw 110A is deactivated by the user, the shop vacuum 110C is deactivated. This allows the dust collection process to be automated, which saves time for the user and provided a more efficient dust extraction.

In some embodiments, the first battery pack 120A and the second battery pack 120B communicate directly bypassing the mobile device 130. The mobile device 130 may be used to communicatively connect the first battery pack 120A and the second battery pack 120B. The mobile device 130 may be used to pair (for example, Bluetooth® pairing) the first battery pack 120A with the second battery pack 120B. For example, a connection may be initiated using a graphical user interface (GUI) of a software application executing on the mobile device 130. In this example, the mobile device 130 may detect that the battery packs 120A, 120B in wireless communication range; display an identifier for the battery packs 120A, 120B on the GUI; and allow a user to select on the GUI the first battery pack 120 and the second battery pack 120B for pairing with each another. To pair the first battery pack 120A with the second battery pack 120B, the mobile device 130 may provide identification information, connection identification information, and/or password information for the connection to each of the first battery pack 120A and the second battery pack 120B. The first battery pack 120A and the second battery pack 120B use the identification information, connection information, and/or password information to subsequently establish a communication link or to communicate with each other. Particularly, the first battery pack 120A and the second battery pack 120B communicate directly to implement the method 600 as provided above.

Thus, embodiments described herein provide, among other things, a system and method for remote control of a power tool device.

What is claimed is:

1. A system for remote controlling a power tool device, the system comprising:
a tool electronic processor included in the power tool device, the power tool device including a battery pack interface; and
a battery pack configured to be coupled to the power tool device at the battery pack interface, the battery pack including:
a pack transceiver, and
a pack electronic processor coupled to the pack transceiver and in communication with the tool electronic processor, the pack electronic processor configured to:
determine that the power tool device is a type of power tool device that is remotely controllable based on a signal from the tool electronic processor,
receive, wirelessly via the pack transceiver, a remote control command from a mobile device, and
provide the remote control command to the power tool device,
wherein the tool electronic processor is configured to control the power tool device to perform an action specified by the remote control command in response to receiving the remote control command from the pack electronic processor.

2. The system of claim 1, wherein the signal is an identification signal.

3. The system of claim 2, wherein the pack electronic processor accesses and retrieves a lookup table from a memory to determine that the power tool device is remotely controllable based on the identification signal.

4. The system of claim 3, wherein the memory is a battery pack memory.

5. The system of claim 3, wherein the memory is a power tool device memory.

6. The system of claim 1, wherein the pack electronic processor provides the remote control command to the tool electronic processor over a communication terminal.

7. The system of claim 1, wherein the pack electronic processor provides the remote control command to the tool electronic processor over a near-field wireless communication link.

8. A method for remote controlling a power tool device by a mobile device, the method comprising:
determining, by a pack electronic processor of a battery pack, that the power tool device is remotely controllable tool type based on a signal from a tool electronic processor,
receiving, wirelessly via a pack transceiver of the battery pack, a remote control command from the mobile device, and
providing, via a communication link between the pack electronic processor and a tool electronic processor of the power tool device, the remote control command to the power tool device in response to determining that the power tool device is remotely controllable tool type,
wherein the tool electronic processor is configured to control the power tool device to perform an action specified by the remote control command in response to receiving the remote control command from the pack electronic processor.

9. The method of claim 8, wherein the signal is an identification signal.

10. The method of claim 9, wherein the pack electronic processor accesses and retrieves a lookup table from a memory to determine that the power tool device is remotely controllable based on the identification signal.

11. The method of claim 9, wherein the identification signal includes an explicit indication that the power tool device is remotely controllable.

12. The method of claim 8 further comprising:
controlling, by the tool electronic processor, the power tool device in a low power mode prior to receiving the remote control command from the pack electronic processor.

13. The method of claim 12 further comprising:
switching, by the tool electronic processor, the power tool device to be controlled in a high power mode to perform the action in response to receiving the remote control command.

14. The method of claim 8 further comprising:
receiving, by the tool electronic processor, position information of a mode switch, and
placing, by the tool electronic processor, the power tool device in a remote control mode in response to the position information indicating the mode switch is in a first mode.

15. The method of claim 14 further comprising:
placing, by the tool electronic processor, the power tool device in a normal mode in response to the position information indicating the mode switch is in a second mode.

16. The method of claim 15, wherein, in the normal mode, the power tool device ignores remote control commands received from the mobile device.

17. The method of claim 8, wherein a graphical user interface of the mobile device displays a list of selectable commands.

18. The method of claim 17 further comprising:
receiving, on the graphical user interface, a selection of a selectable command from the list of selectable commands based on an input at an input interface, and
transmitting, with the mobile device, the remote control command to the battery pack in response to receiving the selection of the selectable command.

19. A system for remote controlling a power tool device, the system comprising:
a transceiver, and
an electronic processor coupled to the transceiver and configured to:
control the power tool device in a low power mode;
receive, wirelessly via the transceiver, a remote control command from a mobile device when the power tool device is in the low power mode, and
in response to receiving the remote control command
control the power tool device in a high power mode, and
perform an action specified by the remote control command.

20. The system of claim 19, wherein, in the low power mode, the power tool device does not draw enough power to perform the action.
